(19) United States
(12) Patent Application Publication
(10) Pub. No.: US 2012/0068918 A1
(43) Pub. Date: Mar. 22, 2012

(54) METHOD AND APPARATUS FOR ELECTRONIC READER OPERATION

(75) Inventors: Ling Jun Wong, Escondido, CA (US); True Xiong, San Diego, CA (US)

(73) Assignee: SONY CORPORATION

(21) Appl. No.: 12/887,649

(22) Filed: Sep. 22, 2010

(51) Int. Cl. G09G 5/00

(52) U.S. Cl. 345/156

(57) ABSTRACT

Methods and apparatus are provided for operation of an electronic reader. In one embodiment, a method includes detecting a user command to initiate playback of the digital text, detecting a playback setting for the digital text based on the user command, displaying a first portion of the digital text by the electronic reader, and updating the display of the digital text by the electronic reader, wherein a second portion of the digital text is automatically displayed based on the playback setting for the digital text.

### FIELD OF THE INVENTION

The present invention relates generally to electronic reader devices and methods, and more particularly to electronic reader (e.g., e-reader) operation to allow for automatic playback of graphical text.

### BACKGROUND OF THE INVENTION

Conventional devices and applications for electronic books, such as E-readers, attempt to simulate the reading of a book. Typically, electronic reader devices display text of the electronic book one page at a time. Some electronic reader devices display either two pages of an electronic book for a user. In order for the additional data of the electronic book to be displayed, a user must activate a button of the electronic reader to cause the electronic reader to display a following page. Thus, conventional electronic reader devices display text of the electronic book in increments of pages. For some users, manually initiating an electronic reader to display text associated with a following page may be burdensome or inconvenient. Accordingly, there exists a need to provide digital text that overcomes one or more of the aforementioned drawbacks.

### BRIEF SUMMARY OF THE INVENTION

Disclosed and claimed herein are methods and apparatus for providing operation of an electronic reader configured to graphically display a digital text. In one embodiment, a method includes detecting, by the electronic reader, a user command to initiate playback of the digital text, detecting a playback setting for the digital text based on the user command, displaying a first portion of the digital text by the electronic reader, and updating the display of the digital text by the electronic reader, wherein a second portion of the digital text is automatically displayed based on the playback setting for the digital text.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a process for operation of an electronic reader configured to graphically display a digital text according to one embodiment;

FIG. 2 depicts a graphical representation of an electronic reader according to one embodiment;

FIG. 3 depicts a simplified block diagram of an electronic reader according to one embodiment;

FIG. 4 depicts a process for operation of an electronic reader according to another embodiment;

FIGS. 5A-5B depict graphical representations electronic reader operation according to one embodiment;

FIG. 6 depicts a process for adjusting playback speed of digital text according to one embodiment; and

FIG. 7 depicts a process for adjusting a playback setting according to another embodiment.

### DETAILED DESCRIPTION OF THE EXEMPLARY EMBODIMENTS

### Overview and Terminology

One aspect of the present invention relates to operation of an electronic reader. In one embodiment, a process is provided for displaying graphical txt of a digital text based on a playback setting. The playback setting may relate to one or more of an automatic setting, a digital text display type, and playback speed for one or more of audio and text. In one embodiment, may include detecting a user input to determine a playback setting. The electronic reader may be configured to store the playback setting. Based on the playback setting the process may include outputting digital text based on the playback setting.

According to another embodiment, an electronic reader is provided that may be configured to allow a user to set and adjust a playback setting for output of digital text. The electronic reader may allow for updating the playback setting of digital text and/or audio data associated with digital text based on the tempo of the audio text. The electronic reader may further be configured to format digital text for display on one or more display sizes.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

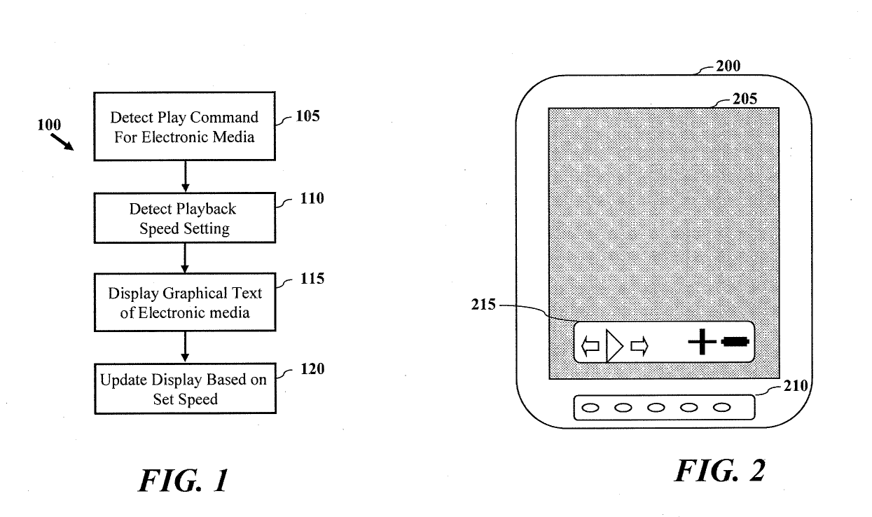

Referring now to the figures, FIG. 1 depicts a process for operation of an electronic reader configured to graphically display a digital text according to one embodiment. Process 100 may be employed for operation of one or more an electronic reader device and electronic reader application executed by a device. Process 100 may be initiated by detecting a user command to initiate playback of digital text at block 105. In one embodiment, the user command relates to a play command for digital text from one of the beginning of the digital text and a previously displayed section of the digital text. At block 110, the electronic reader may detect a playback setting for digital text based on the user command. For example, the playback setting may relate to a user defined speed for automatic playback of the digital text.

Process 100 may then continue by displaying a first portion of the digital text by the electronic reader at block 115. The first portion of the digital text relates to a first portion of the digital text that may be displayed by a display window of the electronic reader. For example, in certain embodiments, the display window of an electronic reader may not be configured to display an entire page of the digital text, thus a first portion may relate to a portion of a digital text that may be displayed in the window. According to another embodiment, the first portion of a digital text may relate to a page of the digital text. At block 120, the electronic device may update the display of the digital text by the electronic reader, wherein a second portion of the digital text is automatically displayed based on the playback setting for the digital text. The second portion of the digital text may relate to a portion of digital text following including a subsection of digital text associated with the first portion, and subsequent text of the digital text. According to another embodiment, updating the display of digital text by the electronic reader may relate to replacing digital text of the first portion with a second portion automatically based on the detected playback speed. Updating the display of digital text by the electronic reader can relate to one or more or scrolling and shifting displayed text of the digital text. In that fashion, digital text may be read without requiring a user to manually change a page of the digital text.

According to another embodiment, process 100 may further include detecting a user adjustment to the playback speed, wherein updating the display is based on the adjusted playback speed. In that fashion, an electronic reader may be configured to adjust the playback speed during playback of digital text or during operation of the electronic reader in general. According to another embodiment, a playback speed may be set and or detected based on an audio file to accompany playback of the digital text. The playback setting of the digital text may be based on the tempo of the audio file. For example, when the digital text includes a corresponding audio track, wherein the text includes audio speech corresponding to the text, the speed for displaying and/or updating display of the digital text may be adjust based on the accompanying audio corresponding to the recording.

Although, process 100 has been described above with reference to display of digital text, it should be appreciated that other types of data and or files may be output by a device based on process 100.

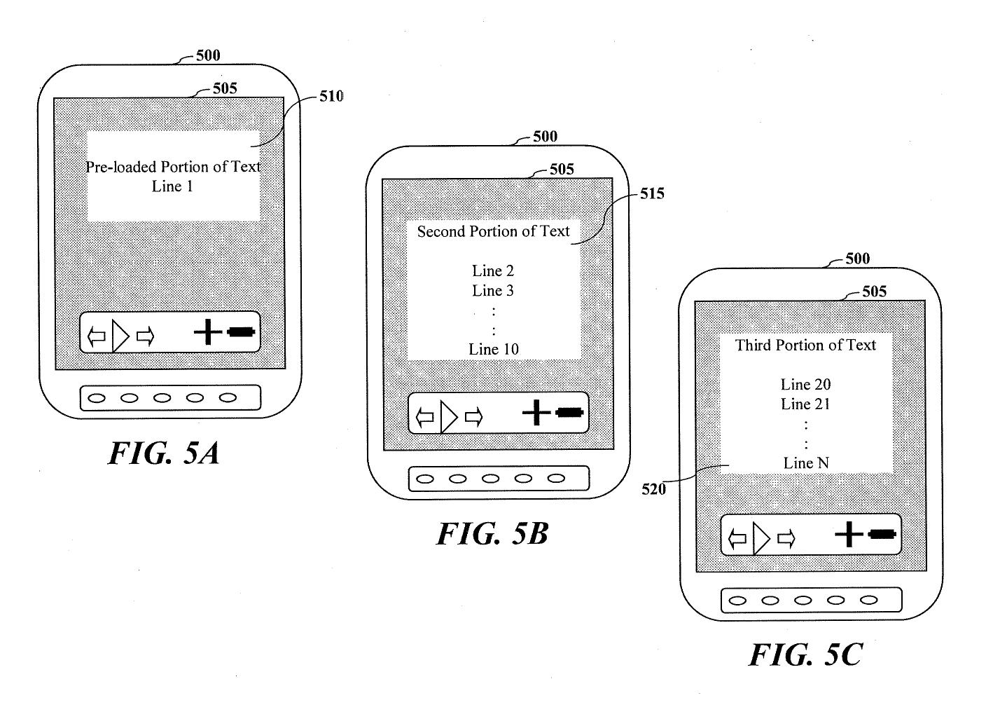

Referring now to FIG. 2, a graphical representation is depicted of an electronic reader according to one embodiment. Electronic reader 200 includes display 205 and may be configured to provide graphical display of one or more pages of digital text. In one embodiment, electronic reader 200 may be configured to employ the process of FIG. 1, to control display of digital text. As will be discussed in more detail below with reference to FIG. 5, display 205 may be configured to automatically update the display of digital text without requiring a user to select turn or select an electronic page. As depicted, electronic reader 200 may include a plurality of buttons, shown as 210 which a user may employ to control operation of the device. For example, buttons 210 may allow a user to select one or more pages, initiate playback of a digital text, turn a page, etc. According to another embodiment, display 205 may display one or more elements which a user may employ to control operation of the electronic reader, depicted as 215. By way of example, controls 215 may allow for a user to initiate playback, advance pages and navigate backwards. Controls 215 may additionally include one or more buttons to control the playback speed shown as 220. Playback speed may be adjustable to a user to set a desired playback rate for a digital text and/or audio.

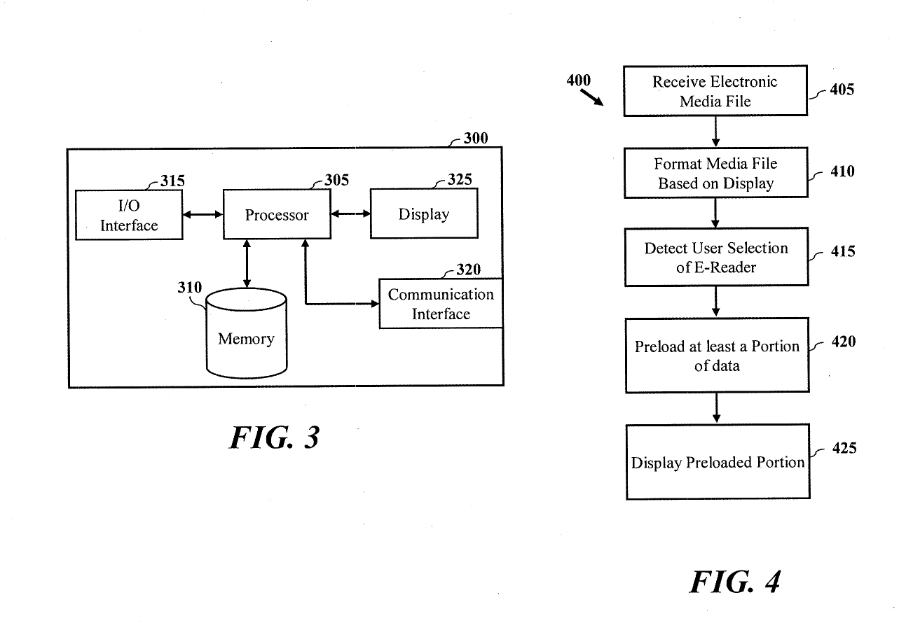

Referring now to FIG. 3, a simplified block diagram of an electronic reader is depicted according to one embodiment. Device 300 relates to an electronic reader. Device 300 may be configured to output audio and/or video. As depicted in FIG. 3, device 300 includes processor 305, memory 310, input/output (I/O) interface 315, network communication interface 320 and display 325. Processor 305 may be configured to control operation of device 300 based on one or more computer executable instructions stored in memory 310. Memory 310 may relate to one of RAM and ROM memories and may be configured to store one or more media files, content, and computer executable instructions for operation of device 300. Processor 305 may additionally be configured to execute one or more applications, including an electronic reader application employing the process of FIG. 1.

I/O interface 315 may include one or more buttons for user input, such as volume control, menu controls, a pointing device, track ball, mode selection buttons, and playback functionality (e.g., play, stop, pause, forward, reverse, slow motion, etc) and speed adjustment. Buttons of I/O interface 315 may include hard and soft buttons, wherein functionality of the soft buttons may be based on one or more applications running on device 300. I/O interface 315 may be configured to allow for one or more devices to communicate with device 300 via wired or wireless communication. I/O interface 315 may include one or more ports for receiving data, including ports for removable memory.

Network communication interface 320 may be configured to allow for network based communications including but not limited to LAN, WAN, Wi-Fi, etc. In one embodiment, communication interface 320 may be configured to provide a messenger application (e.g., messenger application 130). Display 325 may be employed to display digital text associated with an electronic book. Similarly, display 325 may display one or more applications executed by processor 305.

Although FIG. 3 is described above with reference to an electronic reader, it should be appreciated that the methods and devices as discussed herein may be applied to other devices including but not limited to personal computing devices, mobile communication devices, personal digital assistants, media players and electronic devices in general.

Referring now to FIG. 4, a process is depicted for operation of an electronic reader according to another embodiment. In one embodiment, process 400 may be performed to format or configured data associated with a digital text for display. Process 400 may be initiated by receiving an electronic media file at block 405. The electronic media file may include audio data and digital text. At block 410, the media file may be formatted based on the display size of the electronic reader. For example, a digital text may be partitioned into one or more portions, wherein each portion relates to a particular amount of text that may be displayed at one time. Alternatively, the digital test may be partitioned into portions of text, wherein a plurality of portions are displayed at one time. However, during updating of the display, a topmost portion may be replaced, and wherein a new portion is displayed.

At block 415, a user may make a selection of an electronic reader. Select a digital text for playback. In certain embodiments, the user may additionally select the playback speed for updating display text. Based on the user defined playback speed the electronic reader may preload at least a portion of the data, such as digital text, at block 420. In certain embodiments, the electronic reader may additionally preload, audio data associated with a portion of the digital text at block 420. The preloaded portion of the digital text may then be displayed at block 425. Similarly, audio data associated with preloaded text may be output during display of the preloaded text.

Referring now to FIGS. 5A-5B, graphical representations of electronic reader operation are depicted according to one or more embodiments. Electronic reader 500 may relate to the electronic reader of FIG. 2 in one embodiment. Referring first to FIG. 5A, a graphical representation is depicted of an electronic reader when a user initiated playback of a digital text. As depicted in FIG. 5A, the electronic reader displays a preloaded portion of text shown as 510. As depicted the preloaded portion of text relates to one line. However, it should also be appreciated that a plurality of lines may be displayed for preloaded text. According to one embodiment, the electronic reader may display subsequent lines of the digital text until the displayed text nears the bottom of display 505.

Referring now to FIG. 5B, when the displayed text of an electronic reader reaches the bottom of display 505, the electronic reader one or more lines near the top of the display may disappear so that a second portion of the digital text, shown as 515, may be displayed. Text may be displayed as scrolling slowly in one embodiment. According to another embodiment, text may be displayed momentarily, until it is replaced by a display of a subsequent portion. Contrary to conventional methods which require manual page turning, the speed of display of the digital text may further be based on a user setting that is stored or set during display of digital text. According to anther embodiment, the display speed of text in FIGS. 5A-5B may be based on an audio file associated with displayed text. Referring now to FIG. 5C, a third portion of the digital text is depicted as 520. The third portion of digital text may be displayed following text 515. During display of digital text, the user may have the option to advance or rewind the digital text based on activation of one or more electronic reader buttons.

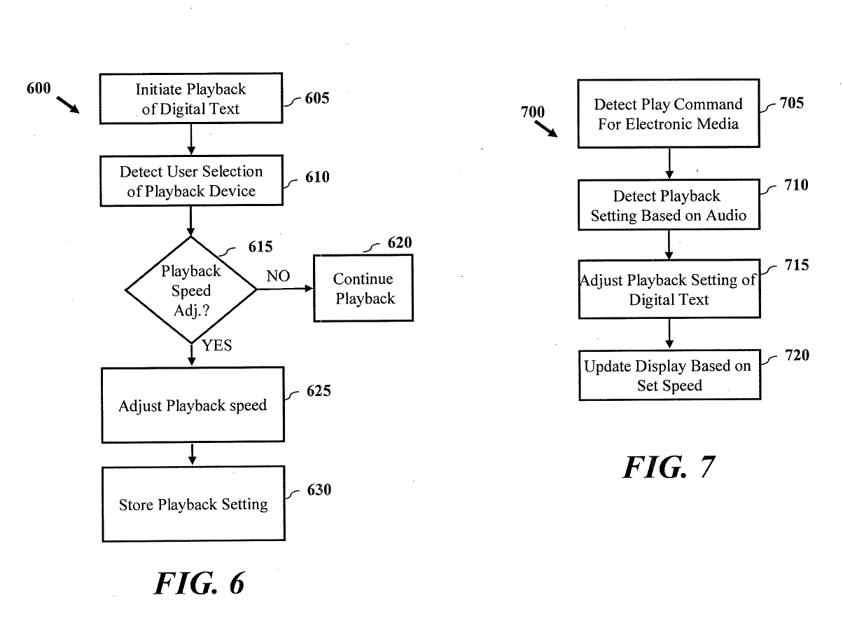

Referring now to FIG. 6, a process is depicted for adjusting playback speed of digital text according to one embodiment. Process 600 may be imitated by a user initiating playback of digital text at block 605. According to one embodiment, playback at block 605 may be initiated for automatic playback of digital text. During playback of digital text, process 600 may advantageously allow for a user to perform selections which may be detected at block 610. At decision block 615, the electronic reader may check if the user selection relates to a playback speed adjustment. When the user selection does not relate to a playback speed adjustment (e.g., “NO” path out of decision block 615), the electronic reader may continue playback at a current playback speed at block 620. When the user selection does relate to a playback speed adjustment (e.g., “YES” path out of decision block 615), the electronic reader may adjust the playback speed at block 625. The electronic reader may additionally store the playback setting at block 630.

Referring now to FIG. 7, a process is depicted for adjusting a playback setting according to another embodiment. According to one embodiment, a playback setting may be adjusted by the electronic reader based on an audio track to be played with digital text. For example, the electronic reader may be configured to play audio data for associated with the digital text, such as a voice recording of the digital text. Process 700 may allow for automatic adjustment of displayed digital text during playback of audio data. Process 700 may be initiated by detecting a play command for electronic media at block 705. The electronic media may relate to digital text and audio data associated with the digital text. Audio data may relate to a voice recording of the digital text, sound effects, and /or music. At block 710, the electronic reader may be configured to detect a playback setting based on the audio data. For example, the rate at which digital text is to be displayed may be based on the tempo of the audio data. For example, digital text may be displayed prior to and shortly after output of audio data, at which time the display of digital text may be replaced with a second portion of digital text. Accordingly, the electronic device may be configured to adjust the playback setting of digital text at block 715 based on the audio data. Based on the adjusted playback setting the electronic reader may output audio and/or digital text. Further, the electronic reader may be configured to update the display of digital text based on one or more of the playback speed setting and output of audio at block 720.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A method for operation of an electronic reader configured to graphically display a digital text, the method comprising the acts of:
detecting, by the electronic reader, a user command to initiate playback of the digital text;
detecting a playback setting for the digital text based on the user command;
displaying a first portion of the digital text by the electronic reader; and
updating the display of the digital text by the electronic reader, wherein a second portion of the digital text is automatically displayed based on the playback setting for the digital text.

2. The method of claim 1, wherein the user command relates to a play command of the digital text from one of the beginning of the digital text and a previously displayed section of the digital text.

3. The method of claim 1, wherein the playback setting relates to a user defined speed for automatic playback of the digital text.

4. The method of claim 1, wherein the first portion of the digital text relates to a first portion of the digital text that may be displayed by a display window of the electronic reader.

5. The method of claim 1, wherein the second portion of the digital text relates to a portion of digital text following including a subsection of digital text associated with the first portion, and subsequent text of the digital text.

6. The method of claim 1, wherein updating the display of digital text by the electronic reader relates to replacing digital text of the first portion with a second portion automatically based on the detected playback speed.

7. The method of claim 1, wherein updating the display of digital text by the electronic reader relates to one or more or scrolling and shifting displayed text of the digital text.

8. The method of claim 1, further comprising detecting a user adjustment to the playback speed, wherein updating the display is based on the adjusted playback speed.

9. The method of claim 1, further comprising detecting a playback speed based on an audio file, wherein the playback setting of the digital text is based on the tempo of the audio file.

10. An electronic reader configured to graphically display a digital text, comprising:
a display;
a memory; and
a processor coupled to the display, and memory, the processor configured to:
detect a user command to initiate playback of the digital text;
detect a playback setting for the digital text based on the user command;
display a first portion of the digital text; and
update the display of the digital text, wherein a second portion of the digital text is automatically displayed based on the playback setting for the digital text.

11. The device of claim 10, wherein the user command relates to a play command of the digital text from one of the beginning of the digital text and a previously displayed section of the digital text.

12. The device of claim 10, wherein the playback setting relates to a user defined speed for automatic playback of the digital text.

13. The device of claim 10, wherein the first portion of the digital text relates to a first portion of the digital text that may be displayed by a display window of the electronic reader.

14. The device of claim 10, wherein the second portion of the digital text relates to a portion of digital text following including a subsection of digital text associated with the first portion, and subsequent text of the digital text.

15. The device of claim 10, wherein updating the display of digital text by the electronic reader relates to replacing digital text of the first portion with a second portion automatically based on the detected playback speed.

16. The device of claim 10, wherein updating the display of digital text by the electronic reader relates to one or more or scrolling and shifting displayed text of the digital text.

17. The device of claim 10, wherein the processor is further configured to detect a user adjustment to the playback speed, wherein updating the display is based on the adjusted playback speed.

18. The device of claim 10, wherein the processor is further configured to detect a playback speed based on an audio file, wherein the playback setting of the digital text is based on the tempo of the audio file.

19. A computer program product stored on computer readable medium including computer executable code for operating of an electronic reader to graphically display a digital text, the computer program product comprising:
computer readable code to detect a user command to initiate playback of the digital text;
computer readable code to detect a playback setting for the digital text based on the user command;
computer readable code to display a first portion of the digital text; and
computer readable code to update the display of the digital text, wherein a second portion of the digital text is automatically displayed based on the playback setting for the digital text.

20. The computer program product of claim 19, wherein the user command relates to a play command of the digital text from one of the beginning of the digital text and a previously displayed section of the digital text.

21. The computer program product of claim 19, wherein the playback setting relates to a user defined speed for automatic playback of the digital text.

22. The computer program product of claim 19, wherein the first portion of the digital text relates to a first portion of the digital text that may be displayed by a display window of the electronic reader.

23. The computer program product of claim 19, wherein the second portion of the digital text relates to a portion of digital text following including a subsection of digital text associated with the first portion, and subsequent text of the digital text.

24. The computer program product of claim 19, wherein updating the display of digital text by the electronic reader relates to replacing digital text of the first portion with a second portion automatically based on the detected playback speed.

25. The computer program product of claim 19, wherein updating the display of digital text by the electronic reader relates to one or more or scrolling and shifting displayed text of the digital text.

26. The computer program product of claim 19, further comprising computer readable code to detect a user adjustment to the playback speed, wherein updating the display is based on the adjusted playback speed.

27. The computer program product of claim 19, further comprising computer readable code to detect a playback speed based on an audio file, wherein the playback setting of the digital text is based on the tempo of the audio file.
